(19) United States
(12) Patent Application Publication
(10) Pub. No.: US 2012/0229142 A1
(43) Pub. Date: Sep. 13, 2012

(54) APPARATUS FOR DETECTING LEAKAGE CURRENT OF BATTERY

(75) Inventors: Jongwoon Yang, Yongin-si (KR); Tetsuya Okada, Yongin-si (KR)

(73) Assignee: Samsung SDI Co., Ltd, Yongin-si (KR)

(21) Appl. No.: 13/242,593

(22) Filed: Sep. 23, 2011

(30) Foreign Application Priority Data
Mar. 10, 2011 (KR) 10-2011-0021341

(51) Int. Cl. G01N 27/416

(52) U.S. Cl. 324/426

(57) ABSTRACT

An apparatus for detecting leakage current of a battery is disclosed. The apparatus includes a leakage current generating unit, a leakage current measuring unit, and a peak holding unit.

### CROSS-REFERENCE TO RELATED APPLICATIONS

This application claims priority to and the benefit of Korean Patent Application No. 10-2011-0021341, filed on Mar. 10, 2011, the entire content of which is incorporated herein by reference.

### BACKGROUND

1. Field

The disclosed technology relates to an apparatus for detecting leakage current of a battery.

2. Description of the Related Technology

Due to fossil energy depletion and environmental pollution, interest electric or hybrid cars, which are driven by a battery instead of fossil energy, has increased. A secondary battery is important to battery driven vehicles. The secondary battery is largely classified as one of a lithium based battery and a nickel hydrogen based battery. A lithium based battery is mainly applied to portable products such as a P-DVD, an MP3P, a mobile phone, a PDA, a Portable Game Device, a power tool, and an E-bike and the nickel hydrogen based battery is mainly applied to products requiring high power such as a car.

In order for the use of a battery to be practical, the battery should be well insulated from the device. This is, if an insulating state is not maintained, leakage current occurs causing various problems. For example, leakage current of a battery causes unexpected battery discharge and malfunctions of electronic equipment within the device using the battery. Additionally, a device using a high voltage battery such as an electric car or a hybrid car driven by a battery may provide an electric shock to people.

### SUMMARY OF CERTAIN INVENTIVE ASPECTS

One inventive aspect is an apparatus for detecting leakage current of a battery. The apparatus includes a leakage current generating unit configured to generate a leakage current for a pulse width modulated Alternating Current (AC) voltage signal, a leakage current measuring unit configured to measure a peak value of the generated leakage current, and a peak holding unit configured to hold a peak value of a leakage current signal output from the leakage current generating unit.

Another inventive aspect is an apparatus for detecting leakage current of a battery. The apparatus includes means for generating a leakage current for a pulse width modulated Alternating Current (AC) voltage signal, means for measuring a peak value of the generated leakage current, and means for holding a peak value of a leakage current signal output from the leakage current generating means.

### BRIEF DESCRIPTION OF THE DRAWINGS

FIG. 1 illustrates a block diagram of an apparatus for detecting leakage current of a battery according to an embodiment;

FIG. 2 illustrates a circuit diagram of an apparatus for detecting leakage current of a battery according to an embodiment;

FIG. 3A illustrates a waveform diagram of an Alternating Current (AC) voltage signal of a leakage current generating unit in an apparatus for detecting leakage current of a battery according to an embodiment;

FIG. 3B illustrates a waveform diagram of a leakage current signal of an apparatus for detecting leakage current of a battery according to an embodiment; and

FIG. 3C illustrates a waveform diagram of a peak holding value in a leakage current measuring unit in an apparatus for detecting leakage current of a battery according to an embodiment.

### DETAILED DESCRIPTION OF CERTAIN INVENTIVE EMBODIMENTS

Example embodiments are described more fully hereinafter with reference to the accompanying drawings; however, the inventive features and aspects may be embodied in different forms and should not be construed as limited to the embodiments set forth herein. Rather, these embodiments are provided so that this disclosure will be thorough and complete.

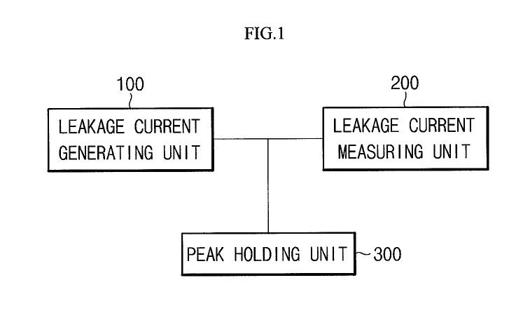

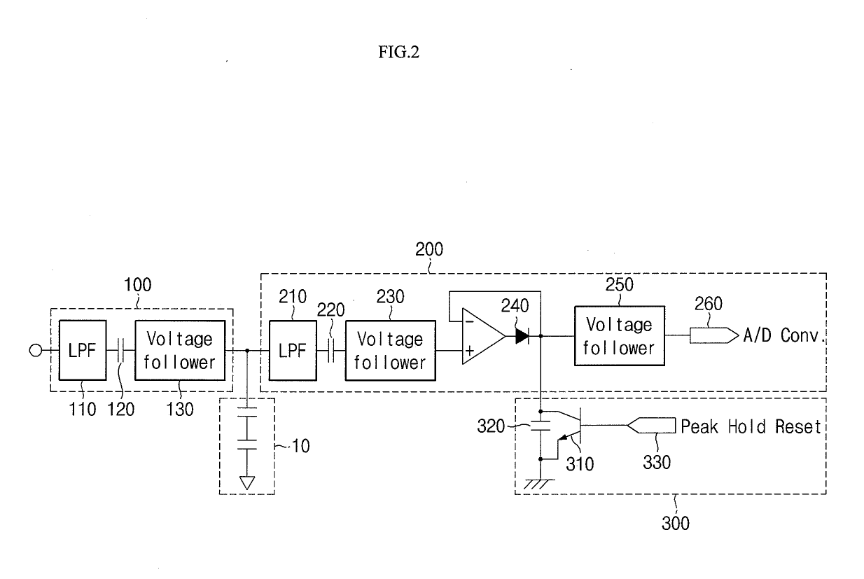

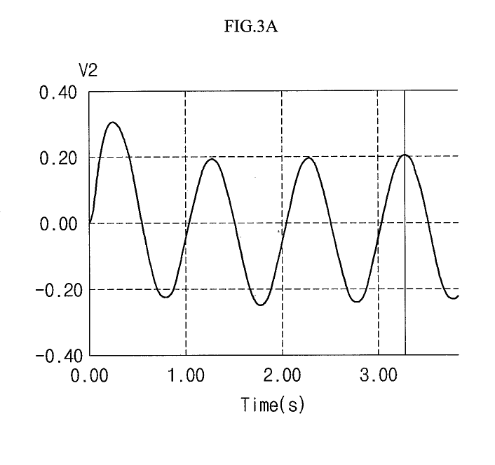

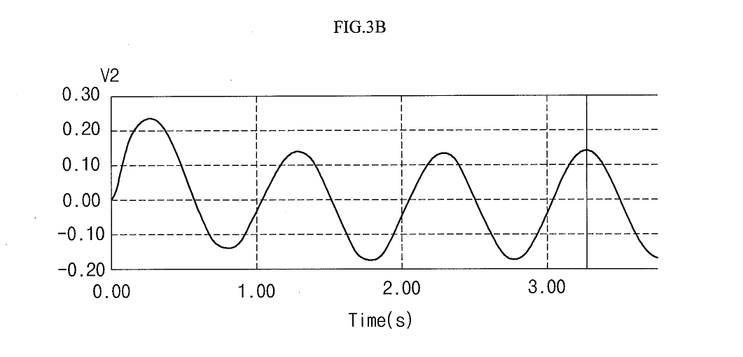

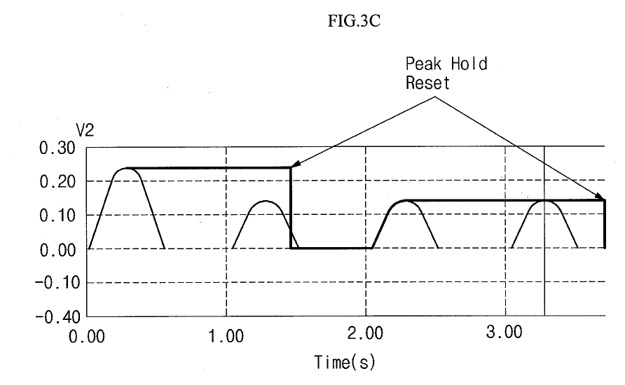

FIG. 1 illustrates a block diagram of an apparatus for detecting leakage current of a battery according to an embodiment. FIG. 2 illustrates a circuit diagram of an apparatus for detecting leakage current of a battery according to an embodiment. FIG. 3A illustrates a waveform diagram of an Alternating Current (AC) voltage signal of a leakage current generating unit in an apparatus for detecting leakage current of a battery according to an embodiment. FIG. 3B illustrates a waveform diagram of a leakage current signal of an apparatus for detecting leakage current of a battery according to an embodiment. FIG. 3C illustrates a waveform diagram of a peak holding value in a leakage current measuring unit in an apparatus for detecting leakage current of a battery according to an embodiment.

As shown in FIGS. 1 and 2, the apparatus for detecting leakage current of a battery according to an embodiment may include a leakage current generating unit 100 and a leakage current measuring unit 200. The leakage current measuring unit 200 may include a peak holding unit 300. The leakage current generating unit 100 may connected to an output of a battery or a battery management system.

The leakage current generating unit 100 generates leakage current from a pulse width modulated AC voltage signal. The leakage current generating unit 100 includes a first LPF 110, a first voltage follower 130, and a first capacitor 120.

The first LPF 110 receives the pulse width modulated AC voltage signal and removes high frequency noise. That is, the first LPF 110 receives a Pulse Width Modulation (PWM) signal and removes high frequency noise in the PWM signal. The first voltage follower 130 amplifies power of an AC voltage signal outputted from the first LPF 110.

As shown in FIG. 3A, the AC voltage signal passing through the leakage current generating unit 100 is a sine wave with a voltage level of about −0.22 to about 0.26. The first capacitor 120 is between the first LPF 110 and the first voltage follower 130 and couples the AC voltage signal from the first LPF 11 as a sine wave.

A coupling capacitor 10 is connected between the leakage generating unit 100 and the leakage current measuring unit 200 and is described in more detail below. The coupling capacitor 10 may also be connected to a negative output of the battery whose leakage is being measured. The coupling capacitor 10 outputs the AC voltage signal when there is no AC leakage current about the voltage waveform. Also, if AC leakage current occurs, the coupling capacitor 10 outputs a relatively small AC voltage signal in proportion to the AC leakage current. Moreover, the coupling capacitor 10 may be connected to a battery, such that it supplies the AC voltage signal or a relatively small AC voltage signal.

The leakage current measuring unit 200 includes a second LPF 210, a second capacitor 220, a second voltage follower 230, a half-wave rectifier 240, a third voltage follower 250, and an A/D converter 260.

The second LPF 210 receives a leakage current signal generated by the leakage current generating unit 100 and removes high frequency noise. That is, the second LPF 210 receives a leakage current signal, which is generated by the leakage current generating unit 100 and the coupling capacitor 10, and removes high frequency noise in the leakage current signal.

The second voltage follower 230 amplifies power of a voltage signal output from the second LPF 210. The second capacitor 220 is between the second LPF 210 and the second voltage follower 230 and couples AC voltage signal output from the second LPF 210 as a sine wave.

As shown in FIG. 3B, the leakage current signal from the coupling capacitor 10 passes through the second LPF 210 and the second voltage follower 230, and is output as a sine wave having a relatively small voltage level of about −0.15 to about 0.22 compared to the waveform of FIG. 3A.

The half-wave rectifier 240 half-wave rectifies a voltage signal having power amplified by the second voltage follower 230. That is, the half-wave rectifier 240 conducts a half-wave of the AC voltage signals passing through the second voltage follower 230 by using a device such as a diode and also generates a forward half-wave by removing the backward half-wave. The third voltage follower 250 amplifies power of a voltage signal output from the half-wave rectifier 240.

The A/D converter 260 converts a voltage signal having amplified power from the third voltage follower 250 into a digital signal. Through A/D converter 260, a peak value in a voltage level of the voltage signal may be measured. A leakage amount may be determined with a voltage level of a peak value. However, in order to accurately measure the peak value, an A/D conversion of a fast speed sufficient for the sine wave frequency is required. Accordingly, a peak holding unit 300 described below may be connected to the output of the half-wave rectifier 240.

The peak holding unit 300 is connected to a node between the half-wave rectifier 240 and the third voltage follower 250, so that it holds a peak value of a leakage current signal output from the leakage current generating unit 100. The peak holding unit 300 includes a transistor 310 and a capacitor 320. The capacitor 320 is connected to between an emitter and a collector of the transistor 310. Additionally, a reset signal holding a peak of the voltage waveform is input to a base of the transistor 310 through a reset signal input unit 330. This reset signal holds a peak value of a sine wave for a predetermined time (e.g., from peak reset to the next reset) so that a fast A/C conversion time for measuring the peak value is unnecessary and a low-speed A/C converter may be used.

As shown in FIG. 3C, after a leakage current signal is half-wave rectified by the half-wave rectifier 240 and its power is amplified by the third voltage follower 250, the leakage current signal whose peak value is held by the peak holding unit 300 may have a peak value held from a peak reset having a voltage level of about 0.22 to the next peak hold reset having a voltage level of about 0.12.

Accordingly, a peak holding unit for holding a peak value of a leakage current signal in order to measure leakage current of a battery, so that a fast A/D conversion time for measuring a peak value of leakage current is unnecessary and in contrast an A/D conversion may be performed at a lower speed. Additionally, an A/D conversion for a sine wave frequency of a leakage current signal is performed at a low speed, so that a peak value of leakage current may be more accurately measured.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure.

What is claimed is:

1. An apparatus for detecting leakage current of a battery, the apparatus comprising:
a leakage current generating unit configured to generate a leakage current for a pulse width modulated Alternating Current (AC) voltage signal;
a leakage current measuring unit configured to measure a peak value of the generated leakage current; and
a peak holding unit configured to hold a peak value of a leakage current signal output from the leakage current generating unit.

2. The apparatus as claimed in claim 1, wherein the leakage current generating unit comprises:
a first Low Pass Filter (LPF) configured to receive a pulse-width modulated AC voltage signal and to filter out high frequency noise; and
a first voltage follower configured to amplify power of an AC voltage signal output from the first LPF.

3. The apparatus as claimed in claim 2, further comprising a first capacitor between the first LPF and the first voltage follower.

4. The apparatus as claimed in claim 1, wherein a coupling capacitor is connected to a node between the leakage current generating unit and the leakage current measuring unit, wherein the leakage current generating unit outputs an AC voltage signal according to the leakage current.

5. The apparatus as claimed in claim 1, wherein the leakage current measuring unit comprises:
a second LPF configured to receive the generated leakage current signal and to filter out high frequency noise;
a second voltage follower configured to amplify power of a voltage signal output from the second LPF;
a half-wave rectifier configured to half-wave rectify a voltage signal having a power amplified by the second voltage follower;
a third voltage follower configured to amplify power of a voltage signal output from the half-wave rectifier; and
an A/D converter configured to convert a voltage signal having power amplified by the third voltage follower into a digital signal.

6. The apparatus as claimed in claim 5, wherein the peak holding unit is connected to a node between the half-wave rectifier and the third voltage follower.

7. The apparatus as claimed in claim 6, wherein the peak holding unit comprises a transistor and a capacitor connected between an emitter and a collector of the transistor.

8. The apparatus as claimed in claim 7, wherein a reset signal is input to the transistor.

9. An apparatus for detecting leakage current of a battery, the apparatus comprising:
means for generating a leakage current for a pulse width modulated Alternating Current (AC) voltage signal;
means for measuring a peak value of the generated leakage current; and
means for holding a peak value of a leakage current signal output from the leakage current generating means.

10. The apparatus as claimed in claim 9, wherein the means for generating a leakage current comprises a leakage current generating unit.

11. The apparatus as claimed in claim 9, wherein the means for measuring a peak value comprises a leakage current measuring unit.

12. The apparatus as claimed in claim 9, wherein the means for holding a peak value comprises a peak holding unit.

13. The apparatus as claimed in claim 9, wherein the leakage current generating means comprises:
a first Low Pass Filter (LPF) configured to receive a pulse-width modulated AC voltage signal and to filter out high frequency noise; and
a first voltage follower configured to amplify power of an AC voltage signal output from the first LPF.

14. The apparatus as claimed in claim 13, further comprising a first capacitor between the first LPF and the first voltage follower.

15. The apparatus as claimed in claim 9, wherein a coupling capacitor is connected to a node between the leakage current generating means and the leakage current measuring means, wherein the leakage current generating means outputs an AC voltage signal according to the leakage current.

16. The apparatus as claimed in claim 9, wherein the leakage current measuring means comprises:
a second LPF configured to receive the generated leakage current signal and to filter out high frequency noise;
a second voltage follower configured to amplify power of a voltage signal output from the second LPF;
a half-wave rectifier configured to half-wave rectify a voltage signal having a power amplified by the second voltage follower;
a third voltage follower configured to amplify power of a voltage signal output from the half-wave rectifier; and
an A/D converter configured to convert a voltage signal having power amplified by the third voltage follower into a digital signal.

17. The apparatus as claimed in claim 16, wherein the peak holding means is connected to a node between the half-wave rectifier and the third voltage follower.

18. The apparatus as claimed in claim 17, wherein the peak holding means comprises a transistor and a capacitor connected between an emitter and a collector of the transistor.

19. The apparatus as claimed in claim 18, wherein a reset signal is input to the transistor.
